(19) United States
(12) Patent Application Publication
(10) Pub. No.: US 2023/0324067 A1
(43) Pub. Date: Oct. 12, 2023

(54) FLOW CONTROL DEVICE FOR AN HVAC FLUID TRANSPORTATION SYSTEM

(71) Applicant: BELIMO HOLDING AG, Hinwil (CH)

(72) Inventors: Philip HOLOCH, Neschwil (CH); Daniel HAUSER, Pfäffikon (CH); Benjamin SCHOENENBERGER, Oetwil am See (CH); Pasquale WINTSCH, Russikon (CH); Michael HEDIGER, Jona (CH); Silvio GROGG, Wetzikon (CH); Peter SCHMIDLIN, Uster (CH)

(73) Assignee: BELIMO HOLDING AG, Hinwil (CH)

(21) Appl. No.: 18/209,662

(22) Filed: Jun. 14, 2023

Related U.S. Application Data
(63) Continuation-in-part of application No. 16/968,395, filed on Aug. 7, 2020, now Pat. No. 11,725,842.

(30) Foreign Application Priority Data
Apr. 24, 2018 (CH) 00525/18

(51) Int. Cl. F24F 11/63; F24F 11/84; F24F 11/89; F24F 11/58; F24F 11/47; G05B 19/042

(52) U.S. Cl. CPC F24F 11/63; F24F 11/84; F24F 11/89; F24F 2130/10; F24F 11/47; G05B 19/042; F24F 11/58

(57) ABSTRACT

A flow control device for an HVAC fluid transportation system includes a sensor module and a logic module. The sensor module includes a flow measurement system to be connected with a flow tube and measures a volumetric flow of a fluid through the flow tube. The sensor module further includes a first electronic circuit connected electrically to the flow measurement system. The logic module is connected to the sensor module and includes a control signal output terminal and a second electronic circuit connected to the first electronic circuit. The second electronic circuit generates and applies on the control signal output terminal an actuator control signal, using the volumetric flow of the fluid measured by the flow measurement system, for an actuator, arranged outside the flow tube of the flow control device, to actuate a valve of the HVAC fluid transportation system.

### FIELD OF THE INVENTION

The present invention relates to a flow control device for an HVAC (Heating, Ventilating, Air Conditioning and Cooling) fluid transportation system. Specifically, the present invention relates to a flow control device comprising a sensor module comprising a flow measurement system configured to measure a volumetric flow of fluid through a flowtube, and a logic module connected to the sensor module.

### BACKGROUND OF THE INVENTION

For HVAC heating and cooling applications, flow sensors or flow meters are used in connection so with monitoring and controlling the hydronic performance of an HVAC system, e.g. for measuring and controlling the volumetric flow of fluid through heat exchangers or cooling devices. The applicant manufactures and offers ultrasonic flow meters which comprise a flow tube and an ultrasonic flow measurement system integrated with the flow tube. Specifically, the flow measurement system comprises a pair of acoustic transceivers (emitters/receivers) and acoustic mirrors which are integrated with the flow tube and configured to transmit and receive ultrasound to and from a measurement path arranged inside the flow tube. The ultrasonic flow measurement system further comprises an electronic circuit connected to the acoustic transceivers and configured to calculate the flow rate of the volumetric flow of fluid through the flow tube from ultrasonic transit times on the measurement path. The electronic circuit generates an electronic signal indicating to external devices the measured flow of fluid via a wire connection. Typically, in existing installations and configurations of HVAC systems, the output signal from a flow sensor is feed to a building control system which generates setpoint values for adjustable control valves, based on the measured flow of fluid and further measurement values, e.g. room temperature, provided to the building control system by respective sensors.

### SUMMARY OF THE INVENTION

It is an object of this invention to provide a flow control device for an HVAC fluid transportation system, which flow control device does not have at least some of the disadvantages of the prior art. In particular, it is an object of the present invention to provide a flow control device which makes it possible to provide HVAC installations efficiently and flexibly with flow-dependent control of actuated valves.

According to the present invention, these objects are achieved through the features of the independent claims. In addition, further advantageous embodiments follow from the dependent claims and the description.

A flow control device for an HVAC fluid transportation system comprises a sensor module comprising a flow measurement system configured to be coupled with a flow tube (pipe), and configured to measure a volumetric flow of fluid through the flow tube, the sensor module further comprising a first electronic circuit connected electrically to the flow measurement system.

According to the present invention, the above-mentioned objects are particularly achieved in that the flow control device further comprises a logic module connected to the sensor module, the logic module comprising a control signal output terminal and a second electronic circuit connected to the first electronic circuit of the sensor module. The second electronic circuit is configured to generate and apply on the control signal output terminal an actuator control signal, using the volumetric flow of fluid measured by the flow measurement system, for an actuator, arranged outside the flow tube of the flow control device, to actuate a valve of the HVAC fluid transportation system. Providing the flow measurement system with a control signal output terminal and an electronic circuit (first and second electronic circuit forming in combination the electronic circuit of the flow control device) for generating and applying on the control signal output terminal an actuator control signal makes it possible for the flow control device to autonomously control a valve of the HVAC fluid transportation system, without having to rely on control functions of a separate building control system. Moreover, existing installations of HVAC systems may be conveniently and efficiently retrofit with autonomous control functions by simply inserting the flow control device fluidically into the HVAC fluid transportation system and connecting the control signal output terminal to the actuator of a valve present in the existing installation of an HVAC system. The flow measurement system is in particular configured to measure the volumetric flow of fluid independently from potentially occurring pressure fluctuations or pressure variations over time during operation. With the pressure independent measured volumetric flow of fluid it is therefore possible to generate and apply the actuator control signal pressure independent.

Providing a flow control device with a control signal output terminal and applying on the control signal output terminal an actuator control signal, has the advantage that the flow control device can be connected flexibly to any type of controllable actuator for controlling performance of the actuator, without any significant delay between the time of flow measurement and the time of actual control of an external actuator.

In an embodiment, the logic module is releasably connected to the sensor module. Releasably means that the logic module can be detached from the sensor module and vice versa. In particular, a housing of the logic module is releasably connected to a housing of the sensor module and vice versa. Further, the sensor module and the logic module may comprise each an electrical interface enabling the releasable electrical connection of the first electronic circuit of the sensor module to the second electronic circuit of the logic module.

In a further embodiment, the logic module is releasably connected to the sensor module via a releasable form fit connection, which preferably comprises a protrusion on the sensor module and a corresponding depression arranged on the logic module or vice versa wherein the protrusion is releasably engageable with the depression for attaching the logic module on the sensor module. The form fit connection may be integrally formed with the housing of the sensor module and the logic module respectively. The form fit connection provides an advantageous fast and precise connection between the sensor module and the logic module. The protrusion of the form fit connection may have an undercut or an excess with respect to the depression, for an advantageous simple connection.

In an embodiment, the logic module of flow control device further comprises a communication module attached to the flow tube and connected to the second electronic circuit, and the second electronic circuit is configured to generate the actuator control signal further using a control command received by the communication module via a communication network. In a further embodiment, the control command is received by the communication module via the communication network from a building control system. The communication module makes it possible for the flow control device to generate the actuator control signal using control commands from a building control system, for example.

In an embodiment, the communication module is configured to receive one or more control parameters via the communication network from a cloud-based computer system, and the second electronic circuit is configured to generate the actuator control signal further using the one or more control parameters received from the cloud-based computer system. Configuring the communication module to receive control parameters from a cloud-based computer system makes it possible for the flow control device to generate the actuator control signal using control parameters which are not available locally at the site of the respective HVAC system.

In an embodiment, the communication module is configured to receive with the one or more control parameters from the cloud-based computer system meteorological weather data, energy pricing information, room temperature information, and/or energy resource availability data; and the second electronic circuit is further configured to generate the actuator control signal further using respectively the meteorological weather data, the energy pricing information, the room temperature information, and/or the energy resource availability data received from the cloud-based computer system.

In an embodiment, the communication module is configured to transmit to the cloud-based computer system one or more operational HVAC data values, including the volumetric flow of fluid measured by the flow measurement system, an air temperature value, an air humidity value, a carbon dioxide value, a carbon monoxide value, a fluid temperature, motor activity data, and/or valve activity data. Configuring the communication module to transmit operational HVAC data values to the cloud-based computer system makes it possible for the flow control device to monitor and analyze the performance of a plurality of HVAC fluid transportation systems and/or actuators, enabling performance improvement based on analytic results.

In an embodiment, the sensor module and/or the logic module of the flow control device further comprises one or more sensor signal input terminals connected to the first or the second electronic circuit respectively, and the second electronic circuit is further configured to generate the actuator control signal further using one or more sensor values received on the one or more sensor signal input terminals. Providing the flow control device with sensor signal input terminals makes it possible for the flow control device to generate the actuator control signal using sensor values which are available locally at the site of the respective HVAC system. The sensors, which are for example connected to the sensor module and/or to the logic module via the sensor signal input terminal are for example arranged outside of the flow control device.

In an embodiment, the one or more sensor signal input terminals include an air temperature sensor input terminal, an air humidity sensor input terminal, a carbon dioxide sensor input terminal, a carbon monoxide sensor input terminal, and/or a fluid temperature sensor input terminal; and the second electronic circuit is further configured to generate the actuator control signal further using respectively an air temperature value, an air humidity value, a carbon dioxide value, a carbon monoxide value, and/or a fluid temperature received on the one or more sensor signal input terminals.

In an embodiment, the one or more sensor signal input terminals are configured to receive a first fluid temperature sensor value from the fluid flowing through the flow tube and a second fluid temperature sensor value from a fluid flowing through an external other flow tube, wherein the second electronic circuit is further configured to generate the actuator control signal further using the first fluid temperature sensor value and the second fluid temperature sensor received on the one or more sensor signal input terminals. The flow control device 1s for example configured to receive two temperatures sensor values from tow temperature sensors, whereof one of the temperature sensor is integrated in the flow tube and whereof the other temperature sensor is integrated in another flow tube of the HVAC system.

In an embodiment, the second electronic circuit is further configured to generate and apply on the control signal output terminal the actuator control signal further using received sensor signal data, for example two sensor signals from temperature sensors. The second electronic circuit is therefore for example configured to generate the actuator control signal using power control determined for example by the volumetric flow of fluid and the two temperature signal data, wherein the first of the temperature signals corresponds to a fluid temperature upstream a consumer and the second of the temperature signals corresponds to a fluid temperature downstream of the consumer. In an embodiment, the logic module of the flow control device further comprises an actuator data input terminal attached to the flow tube and connected to the second electronic circuit, and the second electronic circuit is further configured to generate the actuator control signal further using actuator data received on the actuator data input terminal.

In an embodiment, the second electronic circuit is configured to determine an actuator type from an actuator identifier received on the actuator data input terminal, and to generate the actuator control signal using the actuator type. Configuring the electronic circuit to generate the actuator control signal depending on the actuator type makes it possible to flexibly operate the flow control device with different types of controllable actuators which require different control signals.

In an embodiment, the second electronic circuit is configured to generate the actuator control signal using the volumetric flow of fluid measured by the flow measurement system such as to maintain a set target value for the volumetric flow of fluid.

In an embodiment, the flow measurement system comprises one or more pairs of ultrasound transceivers integrated into a wall of the flow tube and configured to transmit and receive ultrasound to and from a measurement path inside the flow tube. The one or more pairs of ultrasound transceivers advantageously enable the measurement of the volumetric flow of fluid even with pressure variations.

In an embodiment, the flow control device further comprises a data communication bus connecting at least one terminal receiver to the first or second electronic circuit, the at least one terminal receiver being configured to receive and removably attach an auxiliary sensor signal input terminal to the flow control device and connecting the auxiliary sensor signal input terminal to the first or second electronic circuit respectively, and the second electronic circuit is configured to generate the actuator control signal further using one or more sensor values received on the an auxiliary sensor signal input terminal. Providing the flow control device with a terminal receiver makes it possible to flexibly connect and disconnect different sensor signal input terminals, as needed.

In an embodiment, the second electronic circuit is configured to generate the actuator control signal to indicate a motor position, a motor movement direction, a valve position, and/or a degree of opening of a valve orifice.

In an embodiment, the control signal output terminal comprises an antenna configured to wirelessly transmit the actuator control signal to the actuator, and a connector configured to set up a wired connection for applying the actuator control signal to the actuator.

In an embodiment, the flow control device further comprises an antenna configured to receive electromagnetic energy from an external mobile device for powering the first electronic circuit and/or the second electronic circuit and/or the flow measurement system. Having an antenna configured to power the electronic circuit and the flow measurement system with electromagnetic energy transmitted by an external mobile device, enables the flow control device to measure the volumetric flow of fluid through the flow tube, and to generate and apply on the control signal output terminal an actuator control signal, without requiring a wire connection to a power supply.

In an embodiment, the communication module is further configured to provide to the sensor module and/or the logic module electric energy for powering the flow measurement system, the first electronic circuit and/or the second electronic circuit. The communication module is for example configured to provide the electrical power over Ethernet (PoE) to the logic module, which further provides the electrical power to the sensor module, in particular to the first electronic circuit and/or the flow measurement system of the sensor module, for example via the electric connection interface. In a further embodiment, the communication module or another part or portion of the logic module may comprise a power interface, which is configured to provide to the sensor module and/or the logic module electric energy for powering the flow measurement system, the first electronic circuit and/or the second electronic circuit.

In a further embodiment, the flow control device 1s configured to provide electrical energy to the actuator for enabling the actuator to implement the received actuator control signal. The electrical energy for the actuator is, for example, provided from the logic module to the actuator, in particular from the control signal output terminal to the actuator, which reduced complexity.

In an embodiment, the sensor module comprises a memory configured to store received control parameters and the first electronic circuit is configured to process the measured volumetric flow of fluid using the one or more control parameters stored in the memory, wherein the control parameters are preferably received from the communication module. The control parameter may include calibration data, for example calibration tables, which may be used by the first electronic circuit for processing the measured volumetric flow of fluid. The processed flow of fluid is for example stored and collected in the memory and/or transmitted to the second electronic circuit for determining the actuator control signal. Processing the measured volumetric flow by the first electronic circuit enables to

In a further embodiment, the communication module of the logic module comprises a near filed communication interface, wherein the communication module is configured to receive via the near field communication interface control input data from a mobile communication device for controlling and/or commissioning the flow control device. The control input data may include the control parameter, which are transmitted to the memory of the sensor module. The logic module may further comprise a separate memory or has access to the memory of the sensor module. Controlling of the flow control device may comprise to amend or calibrate parameters of the flow control device. Commissioning of the flow control device may comprise to initiate or to set parameters of the flow control device, in particular of the first and/or second electronic control device.

In a further embodiment, the communication module of the logic module is further configured to transmit data of the flow control device to the mobile communication device via the near field communication interface. The mobile communication device can for example read control data and/or measured data of the flow control device to validate the proper functionality of the flow control device in advantageously fast and simple manner.

The near field communication interface may further enable the possibility to completely install and commission the flow control device without external power source. This includes for example parameter settings, configuration, bus addressing and other data processing for the installation protocol. The electrical power is for example provided to the flow control device during installation/commissioning via the near field communication interface or via a battery arranged in the flow control device, no external power source is, for example, needed. It is therefore possible to install/commission the flow control device prior of connecting the flow control device to an external power source, which provides electrical power during normal operation of the flow control device. In a further embodiment, parametrization of the sensor module is achieved for example by means of the mobile device via the NFC interface or by means of a computer device connected to the flow control device via an Ethernet interface, which forms for example part of the communication module of the logic module. Parameterization may include activation of the flow measurement system.

In a further embodiment, an external computer system and or a cloud based server system may be configured to control and distribute authorisation rights to an onsite computer or the onsite mobile communication device. The authorisation rights enable the onsite computer and/or the onsite mobile communication device to access the flow control device, for example via the near filed communication interface or the Ethernet interface, for parameterization/configuration/commissioning of the flow control device or for software updates of the flow control device. In a further embodiment, the flow control device 1s configured to be commissioned powerless by a NFC-based balancer which requires no memory and which reduces a sampling rate. Further, the flow control device may be configured to be parameterization/configuration/commissioning of the flow control device or for software updates of the flow control device via a proprietary bus connection. In a further embodiment, the sensor module comprises an energy storage (battery), which is connected to the first electronic circuit and/or the flow measurement system for at least temporary powering the first electronic circuit and/or the flow measurement system of the sensor module and/or wherein the logic module comprises an energy storage (battery), which is connected to the second electronic circuit for powering at least temporary the second electronic circuit of the logic module. The energy storages are preferably configured to provide electrical energy to the sensor module/logic module of the flow control device during commissioning of the flow control device.

In an embodiment, the sensor module is configured to be powered self-sufficient for a predefined time span, preferably via a non-rechargeable energy storage. In other words, the sensor module can only be powered by the battery (energy storage) comprising a predefined amount of electrical energy, thereby defining a lifespan of the sensor module. The predefined time span or life span is preferably in the range from 10 to 24 months, more preferably for 14 months.

The logic module may further be configured to receive electrical energy via a 24V AC/DC interface.

In an embodiment, the sensor module comprises a display, which is configured to display data of the flow control device and/or to function as control data input terminal for the flow control device, in particular for the first electronic circuit of the sensor module. The display is for example configured to display data only when the presence of a corresponding mobile communication device, having the right access rights, is detected.

In an embodiment, the sensor module is configured to be exchanged from the flow control device after a predefined time period, while keeping the logic module on the flow control device. The sensor module is for example configured to be removed from the flow control device after the predefined lifespan of the energy storage has ended. For removing the sensor module from the flow control device, the logic module may be detached from the sensor module, while all cables going into the logic module, for example, from the building management system, stay connected with the logic module, and while all cables going out of the logic module, for example to the actuator, stay connected with the logic module. In a next step, the sensor module is removed from the piping system, along which the fluid flows, and a new sensor module is installed in the piping system. In a next step, the logic module is attached to the new sensor module. No cable connection needs to be interrupted during the process of exchanging the sensor module.

In a further embodiment, the sensor module is configured to transmit, prior of being removed from the flow control device, data to the logic module, and wherein the logic module is configured to transmit, after being connected to the new sensor module, the received data from the removed sensor module to the new sensor module. Prior of removing the former sensor module, the data transfer is for example initiated via pressing a dedicated button or via transmitting a corresponding control signal from the logic module to the sensor module, for example received via the communication module from the mobile communication device or the communication network. The transferred data may include volumetric flow measurement data, control parameter data of the sensor module or other data collected or received by the sensor module during its operation. After the new sensor module has been installed and the logic module has been attached to the new sensor module, the data is at least partially transmitted, for example automatically, from the logic module to the new sensor module. It is therefore possible that, for example, the control parameter/the commissioning data of the former sensor module are transmitted automatically to the new sensor module, such that the new sensor module can use the same settings etc. as the former sensor module. A specific commissioning and calibration of the new sensor module is therefore advantageously not needed.

In an embodiment, the flow measurement system of the sensor module is configured to measure the volumetric flow of fluid through the flow tube, wherein the fluid comprises water, a water-glycol mixture and/or another heat-transporting fluid, for example gas, like air. Further, the second electronic circuit is configured to generate and apply on the control signal output terminal the actuator control signal for an actuator, enabling the actuator to control the flow of fluid through the flow tube, the fluid comprising water, a water-glycol mixture and/or another heat-transporting fluid, for example gas, like air.

### BRIEF DESCRIPTION OF THE DRAWINGS

The present invention will be explained in more detail, by way of example, with reference to the drawings in which:

FIG. 1: shows a block diagram of a flow control device, illustrating schematically a cross section of a flow tube with an integral flow measurement system, an electronic circuit connected to the flow measurement system, and a control signal output terminal connected to the electronic circuit.

FIG. 2: shows a block diagram of an HVAC system, illustrating schematically an HVAC fluid transportation system with a flow control device having a flow tube, arranged in the HVAC fluid transportation system, an integral flow measurement system, and a control signal output terminal connected to an actuated valve of the HVAC fluid transportation system.

FIG. 3: shows a block diagram of a flow control device comprising a sensor module and a logic module, illustrating schematically a cross section of a flow tube with an integral flow measurement system, an electronic circuit connected to the flow measurement system and a control signal output terminal connected to the electronic circuit according to a further embodiment.

FIG. 4: shows a block diagram of the flow control device as presented in FIG. 3, wherein the logic module is detached from the sensor module.

### DETAILED DESCRIPTION OF THE PREFERRED EMBODIMENTS

In FIGS. 1, 2, 3 and 4, reference numeral 1 refers to a flow control device for an HVAC fluid transportation system 2.

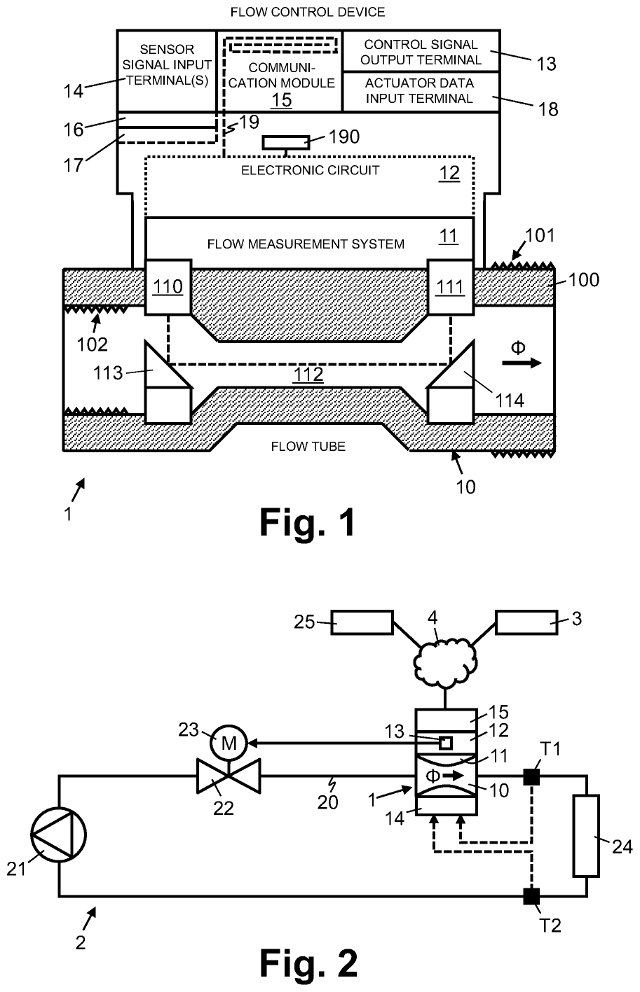

FIG. 2 shows an HVAC fluid transportation system 2 which comprises a fluid driver 21, e.g. a motorized pump or ventilator for moving the fluid (e.g. water or air), a regulating valve 22 actuated by an actuator 23, and a thermal energy exchanger 24, e.g. a heat exchanger or a cooling device, interconnected by fluid transportation lines zo, e.g. pipes or ducts.

As illustrated in FIGS. 1 and 2, the flow control device 2 comprises a flow tube 10. The flow tube 10 is formed in one piece, e.g. from cast iron, and embodies a pipe which can be integrated into the HVAC fluid transportation system 2 such that the fluid moving or circulating in the HVAC fluid transportation system 2 moves or flows through the flow tube 10. The flow tube 10 comprises a wall 100 with interior and exterior threads 101, 102 for connecting the flow tube 10 to pipes of the HVAC fluid transportation system 2.

The flow control device 2 comprises a flow measurement system 11 integrated with the flow tube 10. In an embodiment, the flow measurement system 11 includes an ultrasonic flow sensor comprising one or more pairs of ultrasound transceivers 110, 111 and acoustic mirrors 113, 114. The ultrasound transceivers 110, 111 are integrated into the wall 100 of the flow tube 10. The ultrasound transceivers 110, 111 are configured to transmit and receive ultrasound to and from a measurement path 112 arranged inside the flow tube 10. As illustrated in FIG. 2, the measurement path 112 extends from one of the ultrasound transceivers 110, 111 (of a pair) via the acoustic mirrors 113, 114 to the other one of the ultrasound transceivers 110, 111 (of the respective pair). The flow measurement system 11 is configured to determine the volumetric flow of fluid ϕ through the flow tube 10 based on measured transit times of the ultrasound on the measurement path 112, in both directions between the ultrasound transceivers 110, 111 of a respective pair. For calculating the volumetric flow of fluid ϕ the flow measurement system 11 comprises an electronic circuit connected to the ultrasound transceivers 110, 111.

As illustrated in FIGS. 1 and 2, the flow control device 2 comprises an electronic circuit 12 attached to the flow tube 10. As indicated by the dotted line in FIG. 1, in an embodiment, the electronic circuit 12 is part of the flow measurement system 11. Otherwise, the electronic circuit 12 is electrically connected to the flow measurement system 11. Depending on the embodiment, the electronic circuit 12 comprises a programmable processor, an application specific integrated circuit (ASIC), or another logic unit.

According to the embodiment as shown in FIG. 1, the flow control device 1 comprises the flow control device 1, may be subdivided in a sensor portion and in a logic portion within one housing sharing the electronic circuit 12. The sensor portion comprising all sensing features, for example the flow measurement system, and the logic portion comprising further features. The electronic circuit 12, may be allocated to the sensor portion or to the logic portion of the flow control device 1 or to both, as indicated by the dotted line in FIG. 1.

The flow control device 2 comprises a control signal output terminal 13 attached to the flow tube 10 and connected to the electronic circuit 12. The electronic circuit 12 is configured to generate and apply on the control signal output terminal 13 an actuator control signal, using the volumetric flow of fluid ϕ determined by the flow measurement system 11. The actuator control signal is generated to control the actuator 23 actuating the valve 22 such as to regulate the flow of fluid ϕ in the HVAC fluid transportation system 2 depending on the measured flow of fluid ϕ. For example, the electronic circuit 12 generates the actuator control signal based on the measured flow ϕ such as to maintain a set target flow, e.g. stored in the electronic circuit 12, regardless of pressure variations. Depending on the configuration, the actuator control signal indicates and defines for the actuator 23 a motor position, a motor movement direction, a motor speed, a valve position for the valve 22, and/or a degree of opening of the valve orifice of the valve 22. The control signal output terminal 13 comprises an antenna for wirelessly transmitting the actuator control signal to the actuator 23 and/or an electrical or optical connector for setting up a wired connection to apply the actuator control signal to the actuator 23.

As illustrated in FIGS. 1 and 2, the flow control device 2 comprises a communication module attached to the flow tube 10 and connected to the electronic circuit 12. The communication module 15 is configured for data communication via a communication network 4, e.g. with a building control system 25, located at the site of the HVAC fluid transportation system 2, or a remote cloud-based computer system 3. Depending on the embodiment, the communication network 4 comprises a local area network (LAN), a wireless local area network (WLAN), a mobile radio network, such as GSM (Global System for Mobile Communication) or UMTS (Universal Mobile Telephone System), and/or the Internet. The building control system 25 and the cloud-based computer system 3, respectively, comprise one or more networked computers with one or more processors per computer.

As illustrated schematically in FIG. 1, in an embodiment, the flow control device 1 comprises an antenna 19, e.g. as part of the communication module 15, which is connected to the electronic circuit 12 and configured to receive electromagnetic energy from an external mobile device for powering the electronic circuit 12 and the flow measurement system 11. For example, the mobile device 1s a mobile phone or another electronic device including an RFID (Radio Frequency Identifier) or NFC (Near Field Communication) module for wirelessly powering the flow control device 1 (per induction). In an embodiment, the flow control device 1 comprises an energy storage 190, e.g. a battery or a supercap, for example a lithium-ion capacitor (LIC), which is connected to the electronic circuit 12 and the flow measurement system 11 for powering the electronic circuit 12 and the flow measurement system 11. Depending on the embodiment, the energy storage 190 is charged by the mobile device, wirelessly via antenna 19, or by a power supply, through a wire connection. The energy storage is connected to the electronic circuit 12 and the flow measurement system 11 via a switch, which is activated, for example, by an external device through an RFID or NFC interface.

The electronic circuit 12 is configured to generate the actuator control signal further using data received by the communication module 15 via the communication network 4 from the building control system 25 and/or the cloud-based computer system 3. Depending on the embodiment and/or application, the data includes control commands and/or control parameters from the building control system 25 and/or the cloud-based computer system 3. The control commands include a target room temperature, a maximum amount of energy to be used, a maximum power level to be used, and/or other command data for the electronic circuit 12 to generate the actuator control signal. The control parameters include meteorological weather data, energy pricing information, room temperature information, energy resource availability data, and/or other control data for the electronic circuit 12 to generate the actuator control signal.

As illustrated in FIGS. 1 and 2, the flow control device 2 further comprises an actuator data input terminal 18 attached to the flow tube 10 and connected to the electronic circuit 12. The actuator data input terminal 18 comprises an antenna for wirelessly receiving and/or an electrical or optical connector for receiving through a wired connection actuator data from the actuator 23. The actuator data includes an actuator identifier indicating the type and (serial) number of the actuator 23, and/or operational data of the actuator 23, such as number of movements, number of directional changes, idle time, and time of operation of the actuator 23. The electronic circuit 12 is configured to generate the actuator control signal further using actuator data received on the actuator data input terminal 18. For example, the electronic circuit 12 generates the actuator control signal with different coding and/or voltage levels, depending on the type of the actuator 23.

As illustrated in FIGS. 1 and 2, the flow control device 2 further comprises one or more sensor signal input terminals 14 attached to the flow tube 10 and connected to the electronic circuit 12. In an embodiment, for added flexibility and configurability, the flow control device 1 further comprises a data communication bus 17 connecting one or more terminal receivers 16 to the electronic circuit 12. The terminal receivers 16 are configured to receive and removably attach an auxiliary sensor signal input terminal 14 to the flow tube 10 and to connect the auxiliary sensor signal input terminal 14 to the electronic circuit 12. Depending on the embodiment and configuration, the fixed or removable sensor signal input terminals 14 include an air temperature sensor input terminal, an air humidity sensor input terminal, a carbon dioxide sensor input terminal, a carbon monoxide sensor input terminal, and/or a fluid temperature sensor input terminal. The electronic circuit 12 is further configured to generate the actuator control signal further using one or more sensor values received on the one or more sensor signal input terminals 14 and/or attached auxiliary sensor signal input terminals 14, including an air temperature value, an air humidity value, a carbon dioxide value, a carbon monoxide value, and/or a fluid temperature value.

The electronic circuit 12 is thus configured to generate and apply the actuator control signal based on the measured current flow of fluid ϕ, the command and control data received form the building control system 25 and/or the cloud-based computer system 3, and the sensor values received from one or more sensors connected to the sensor signal input terminals 14 and/or attached auxiliary sensor signal input terminals 14, for controlling the actuator 23 to actuate the valve 22 and regulate the flow of fluid ϕ in the HVAC fluid transportation system 2. For example, the electronic circuit 12 is configured to regulate the flow of fluid ϕ in the HVAC fluid transportation system 2 such as to reach a desired room temperature, defined in a setpoint from a user terminal, the building control system 25 or the cloud-based computer system 3, based on the current flow of fluid ϕ, measured by the flow measurement system 11, and the actual room temperature value, received at the sensor signal input terminal 14 and/or attached auxiliary sensor signal input terminal 14 from a room temperature sensor.

The electronic circuit 12 is further configured to use the communication module 15 to transmit via the communication network 4 to the building control system 25 and/or the cloud-based computer system 3 operational HVAC data, such as the current measurement values provided by sensors connected to the sensor signal input terminal 14, for example, an air humidity value measured by a temperature sensor connected to the air temperature sensor input terminal, an air humidity value measured by an air humidity sensor connected to the air humidity sensor input terminal, a carbon dioxide value measured by carbon dioxide sensor connected to the carbon dioxide sensor input terminal, a carbon monoxide value measured by carbon monoxide sensor connected to the carbon monoxide sensor input terminal, and a fluid temperature measured by a temperature sensor T1, T2 connected to the fluid temperature sensor input terminal; and actuator data as described above including motor activity data and valve activity data.

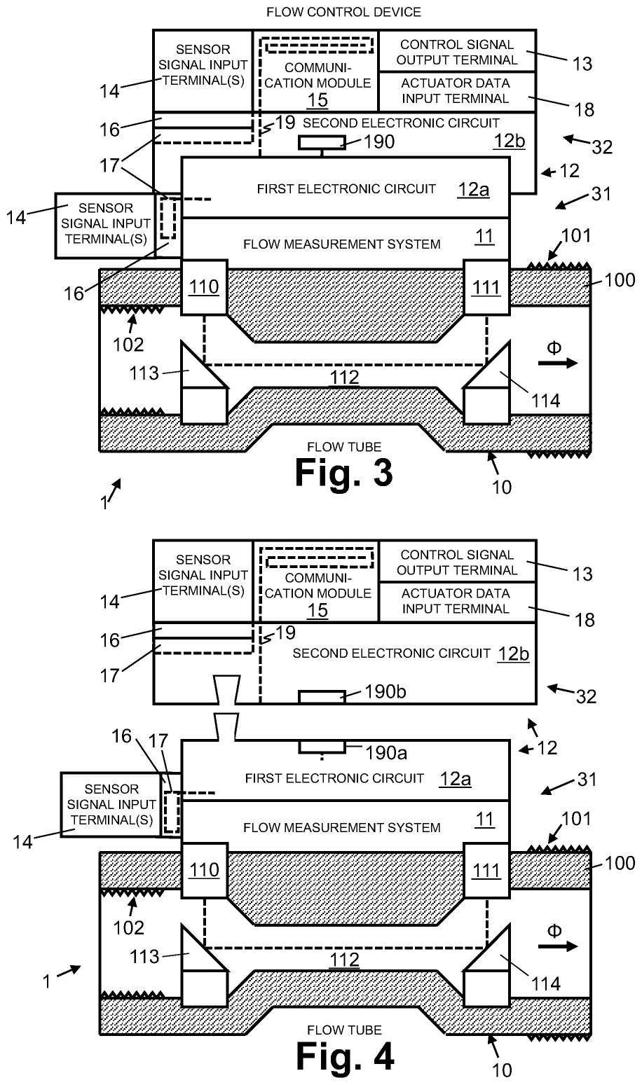

FIG. 3 shows the flow control device 1 according to another embodiment. This embodiment differs from the embodiment as shown for example in FIG. 1 in that the electronic circuit 12 comprises a first electronic circuit 12a and a second electronic circuit 12b. The first electronic circuit 12a is assigned to a sensor module 31 of the flow control device 1 and the second electronic circuit 12b is assigned to a logic module 32 of the flow control device 1. The sensor module 31 and the logic module 32 form in combination at least partially the flow control device 1. The electronic circuit 12 of this embodiment is for example partitioned in the first electronic circuit 12a arranged in the sensor module 31 and in the second electronic circuit 12b arranged in the logic module 32. The sensor module 31 further comprises the flow measurement system 11 connected with the flow tube 10 for measuring the volumetric flow of fluid through the flow tube. The logic module 32, which is connected to the sensor module 31, comprises besides the second electronic circuit 12b, the communication module 15, the control signal output terminal 13, the actuator data input terminal 18, the sensor signal input terminal(s) 14, the terminal receiver 16 and the data communication bus 17. The logic module 32 may further comprise a memory and/or an energy storage 190 (battery). The communication module 15, the control so signal output terminal 13, the actuator data input terminal 18, the sensor signal input terminal(s) 14, the terminal receiver 16 and the data communication bus 17, the memory and/or the battery are for example connected to the second electronic circuit 12b of the electronic circuit 12, such that the required functionality of the different components as described above and hereinafter can be provided. The sensor module 31 as shown in FIG. 3 comprises in this embodiment additionally a sensor signal input terminal 14, a terminal receiver 16 and a data communication bus 17 configured to transfer the data received from the sensor signal input terminal 14 to the first electronic circuit 12a. The sensor signal input terminal 14 of the sensor module 31 is for example configured to receive temperature data from a temperature sensor and to transmit the temperature data to the first electronic circuit 12a. The sensor module 31 as shown in FIG. 3 may further comprise an own energy storage or has access to the energy storage 190. It is preferred that the sensor module 31 comprise its own energy storage 190 (as for example shown in FIG. 4. The energy storage 190 of the sensor module 31 may be configured to provide for a predefined timespan, for example fourteen months, energy to the sensor module 31, in particular to the first electronic circuit 12a and the flow measurement system 11. After the expiration of the predefined timespan, the sensor module 31 is exchanged, while the logic module 32 may remain on the flow control device 1. An advantageous simple separation of the logic module 32 from the sensor module is realizable when the logic module 32 comprises a separate housing and the sensor module 31 comprises a separate housing. In particular advantageous is, when the housing of the logic module 32 is detachable connected to the housing of the sensor module 31.

FIG. 4 shows the flow control device 1 in an embodiment where the logic module 32 is detached from the sensor module 31. A mechanical connection interface between the logic module 32 and the sensor module 31 may comprise a form fit connection for an advantageous simple and reliable connection between these two portions of the flow control device 1. The embodiment of FIG. 4 further shows that the sensor module 31 comprises its own energy storage 190a and that the logic module 32 comprises its own energy storage 190b. The energy storage 190b is for example configured to provide at least temporarily electrical energy to the second electronic circuit 12b during operation of the flow control device 1. FIG. 4 further shows a protrusion in the sensor module 31 and a depression in the logic module 32 forming a form fit connection for an advantageous connection of the logic module 32 on the sensor module 31.

1. A flow control device for an HVAC fluid transportation system, the flow control device comprising:
a sensor module comprising a flow measurement system configured to be connected with a flow tube and configured to measure a volumetric flow of a fluid through the flow tube, the sensor module further comprising a first electronic circuit connected electrically to the flow measurement system;
a logic module connected to the sensor module, the logic module comprising a control signal output terminal and a second electronic circuit connected to the first electronic circuit, and the second electronic circuit is configured to generate and apply on the control signal output terminal an actuator control signal, using the volumetric flow of the fluid measured by the flow measurement system, for an actuator, arranged outside the flow tube of the flow control device, to actuate a valve of the HVAC fluid transportation system.

2. The flow control device of claim 1, wherein the logic module is releasably connected to the sensor module.

3. The flow control device of claim 2, wherein the logic module is releasably connected to the sensor module via a releasable form fit connection, which comprises a protrusion arranged on the sensor module and a depression arranged on the logic module, wherein the protrusion is releasably engageable with the depression for attaching the logic module on the sensor module.

4. The flow control device of claim 1, wherein the logic module of the flow control device further comprises a communication module connected to the second electronic circuit, and the second electronic circuit is configured to generate the actuator control signal further using a control command received by the communication module via a communication network.

5. The flow control device of claim 4, wherein the communication module is configured to receive one or more control parameters via the communication network from a cloud-based computer system, and the second electronic circuit is configured to generate the actuator control signal further using the one or more control parameters received from the cloud-based computer system.

6. The flow control device of claim 5, wherein the communication module is configured to receive with the one or more control parameters from the cloud-based computer system at least one of: meteorological weather data, energy pricing information, room temperature information, and energy resource availability data; and the electronic circuit is further configured to generate the actuator control signal further using respectively at least one of: meteorological weather data, energy pricing information, room temperature information, and energy resource availability data received from the cloud-based computer system.

7. The flow control device of claim 4, wherein the communication module is configured to transmit to the cloud-based computer system one or more operational HVAC data values, including at least one of: the volumetric flow of the fluid measured by the flow measurement system, an air temperature value, an air humidity value, a carbon dioxide value, a carbon monoxide value, a fluid temperature, motor activity data, and valve activity data.

8. The flow control device of claim 1, wherein at least one of: the sensor module or the logic module of the flow control device further comprises one or more sensor signal input terminals connected to the first or second electronic circuit respectively, and the second electronic circuit is further configured to generate the actuator control signal further using one or more sensor values received on the one or more sensor signal input terminals.

9. The flow control device of claim 8, wherein the one or more sensor signal input terminals include at least one of: an air temperature sensor input terminal, an air humidity sensor input terminal, a carbon dioxide sensor input terminal, a carbon monoxide sensor input terminal, and a fluid temperature sensor input terminal; and the second electronic circuit is further configured to generate the actuator control signal further using respectively at least one of: an air temperature value, an air humidity value, a carbon dioxide value, a carbon monoxide value, and a fluid temperature received on the one or more sensor signal input terminals.

10. The flow control device according to claim 8, wherein the one or more sensor signal input terminals are configured to receive a first fluid temperature sensor value from the fluid flowing through the flow tube and a second fluid temperature sensor value from a fluid flowing through an external flow tube, wherein the second electronic circuit is further configured to generate the actuator control signal further using the first fluid temperature sensor value and the second fluid temperature sensor received on the one or more sensor signal input terminals.

11. The flow control device of claim 1, wherein the logic module of the flow control device further comprises an actuator data input terminal connected to the second electronic circuit, and the second electronic circuit is further configured to generate the actuator control signal further using actuator data received on the actuator data input terminal.

12. The flow control device of claim 11, wherein the second electronic circuit is configured to determine an actuator type from an actuator identifier received on the actuator data input terminal, and to generate the actuator control signal using the actuator type.

13. The flow control device of claim 1, wherein the second electronic circuit is configured to generate the actuator control signal using the volumetric flow of the fluid measured by the flow measurement system such as to maintain a set target value for the volumetric flow of the fluid.

14. The flow control device of claim 1, wherein flow measurement system comprises one or more pairs of ultrasound transceivers integrated into a wall of the flow tube and configured to transmit and receive ultrasound to and from a measurement path inside the flow tube.

15. The flow control device of claim 1, wherein the flow control device further comprises a data communication bus connecting at least one terminal receiver to the first or second electronic circuit, the at least one terminal receiver being configured to receive and removably attach an auxiliary sensor signal input terminal to the flow control device and connecting the auxiliary sensor signal input terminal to the first or second electronic circuit respectively, and the second electronic circuit is configured to generate the actuator control signal further using one or more sensor values received on the auxiliary sensor signal input terminal.

16. The flow control device of claim 1, wherein the second electronic circuit is configured to generate the actuator control signal to indicate at least one of: a motor position, a motor movement direction, a valve position, and a degree of opening of a valve orifice.

17. The flow control device of claim 1, wherein the control signal output terminal comprises at least one of: an antenna configured to wirelessly transmit the actuator control signal to the actuator, and a connector configured to set up a wired connection for applying the actuator control signal to the actuator.

18. The flow control device of claim 1, wherein the flow control device further comprises an antenna configured to receive electromagnetic energy from an external mobile device for powering at least one of: the first electronic circuit, the second electronic circuit or the flow measurement system.

19. The flow control device of claim 4, wherein the communication module is further configured to provide to at least one of: the sensor module or the logic module electric energy for powering at least one of: the flow measurement system, the first electronic circuit or the second electronic circuit.

20. The flow control device of claim 1, wherein the sensor module comprises a memory configured to store received control parameters and the first electronic circuit is configured to process the measured volumetric flow of the fluid using the one or more control parameters stored in the memory, wherein the control parameters are preferably received from the communication module.

21. The flow control device of claim 4, wherein the communication module comprises a near filed communication interface, wherein the communication module is configured to receive via the near field communication interface control input data from a mobile communication device for controlling and/or commissioning the flow control device.

22. The flow control device of claim 1, wherein the sensor module comprises an energy storage, which is connected to the first electronic circuit and/or the flow measurement system for at least temporary powering the first electronic circuit and/or the flow measurement system of the sensor module and/or wherein the logic module comprises an energy storage, which is connected to the second electronic circuit for powering at least temporary the second electronic circuit of the logic module.

23. The flow control device of claim 1, wherein the sensor module comprises a display, which is configured to display data of the flow control device and/or to function as control data input terminal for the flow control device, in particular for the first electronic circuit.

24. The flow control device of claim 1, wherein the sensor module is configured to be exchanged from the flow control device after a predefined time period, while keeping the logic module on the flow control device.

25. The flow control device of claim 24, wherein the sensor module is configured to transmit, prior of being removed from the flow control device, data to the logic module and wherein the logic module is configured to transmit, after being connected to the newly added sensor module, the received data from the removed sensor module to the newly added sensor module.

26. A HVAC fluid transportation system comprising the flow control device according to claim 1 and an actuator arranged outside of the flow control device and configured to actuate a valve of HVAC fluid transportation system using the actuator control signal generated by the second electronic circuit of the flow control device.
